(19) United States
(12) Patent Application Publication
(10) Pub. No.: US 2014/0000274 A1
(43) Pub. Date: Jan. 2, 2014

(54) METHODS AND APPARATUS FOR CO-FIRING FUEL

(71) Applicants: Ram Srinivasan, San Diego, CA (US); Colin John Etheridge, Chula Vista, CA (US)

(72) Inventors: Ram Srinivasan, San Diego, CA (US); Colin John Etheridge, Chula Vista, CA (US)

(21) Appl. No.: 13/538,099

(22) Filed: Jun. 29, 2012

(51) Int. Cl. F02C 3/20

(52) U.S. Cl. 60/776

(57) ABSTRACT

A method of co-firing fuel within a gas turbine engine. The method may include injecting a first fuel into a combustion system of a gas turbine engine. The first fuel may include a high energy liquid fuel. The method may also include injecting a second fuel into the combustion system. The second fuel may include a gaseous low Wobbe fuel. Only the first fuel may be injected during a first mode of operation. The first fuel and the second fuel may be injected simultaneously and discretely during a second mode of operation.

### TECHNICAL FIELD

The present disclosure relates generally to a turbine engine, and more particularly, to methods for co-firing fuel within a turbine engine.

### BACKGROUND

Gas turbine engines (GTEs) produce power by extracting energy from a flow of hot gas produced by combustion of fuel in a stream of compressed air. In general, GTEs have an upstream air compressor coupled to a downstream turbine with a combustion chamber (combustor) in between. Energy is produced when a mixture of compressed air and fuel is burned in the combustor, and the resulting hot gases are used to spin blades of a turbine. In typical GTEs, a main rotary shaft extends along an engine axis and couples rotational movement of various components of the GTE about the engine axis.

In a typical turbine engine, one or more fuel injectors direct some type of liquid or gaseous fuel (such as diesel fuel or natural gas liquid fuel), or combinations thereof, into the combustor for combustion. This fuel mixes with compressed air (from the air compressor) in the fuel injector, and flow to the combustor for combustion. The amount of combustion energy output and injection pressure requirements may vary largely based on the type of fuel(s) selected for injection.

U.S. Pat. No. 4,833,878 to Sood et al. (the '878 patent), discloses a wide range gaseous fuel combustion system for gas turbine engines. The disclosed system allows a high calorific fuel to be delivered to an engine during startup, and subsequently introduces a lower calorific fuel. The disclosed system further decreases the amount of high calorific fuel to be introduced until the gas turbine engine operates on the lower calorific fuel alone.

### SUMMARY

Embodiments of the present disclosure may be directed to a method of co-firing fuel within a gas turbine engine. The method may include injecting a first fuel into a combustion system of a gas turbine engine. The first fuel may include a high energy liquid fuel. The method may also include injecting a second fuel into the combustion system. The second fuel may include a gaseous low Wobbe fuel. Only the first fuel may be injected during a first mode of operation. The first fuel and the second fuel may be injected simultaneously and discretely during a second mode of operation.

In further embodiments, the present disclosure may include a method of co-firing fuel within a gas turbine engine. The method may include determining a transition percentage of load of the gas turbine engine and injecting a first fuel into a combustion system of the gas turbine engine. The first fuel may include a high energy liquid fuel. Further, the method may include co-firing the first fuel with a second fuel in the combustion system after exceeding the transition percentage load of the gas turbine engine. The second fuel may include a gaseous low Wobbe fuel. Additionally, the first fuel and the second fuel may be injected simultaneously and discretely. Also, the transition percentage load may be a function of one or more of a variety of inputs by an operator, inputs received from one or more sensors associated with the gas turbine engine, and a manufacturer suggested rating of the load of the gas turbine engine.

In further embodiments, the present disclosure may be directed to a method of co-firing fuel within a gas turbine engine. The method may include injecting a first fuel into a combustion system of the gas turbine engine during a first mode. The first fuel may include a high energy liquid fuel. The method may also include determining a transition percentage of load of the gas turbine engine. Additionally, the method may include co-firing the first fuel with a second fuel in the combustion system after exceeding the transition percentage load of the gas turbine engine during a second mode. The second fuel may include a gaseous low Wobbe fuel. The method may further include maintaining an amount of first fuel injected into the combustion system constant during the second mode. Also, the first fuel and the second fuel may be co-fired discretely of each other. Further, the second fuel may be injected below a predetermined injection pressure limit.

### BRIEF DESCRIPTION OF THE DRAWINGS

FIG. 1 is a schematic illustration of an exemplary GTE;

FIG. 2 is a schematic illustration of an exemplary fuel injector for the GTE of FIG. 1;

FIG. 3 is an exemplary method of co-firing fuels within the GTE of FIG. 1; and

FIG. 4 depicts an exemplary graphical representation comparing the skid-edge pressure (injection pressure) to the percentage load of the exemplary GTE of FIG. 1.

### DETAILED DESCRIPTION

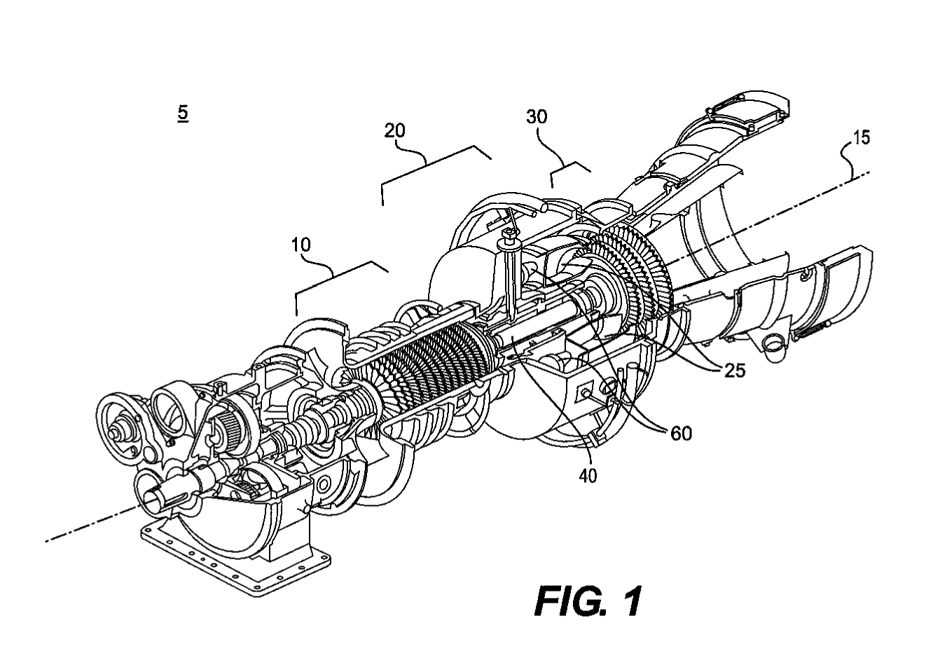

FIG. 1 illustrates an exemplary schematic gas turbine engine (GTE) 5 having a compressor system 10, a combustion system 20, and a turbine system 30 arranged lengthwise along an engine axis 15 on a rotary shaft 40. The compressor system 10 is configured to compress air and deliver the compressed air to the combustion system 20, including a combustor 25. The compressor system 10 may include a plurality of stationary blades or nozzles and a plurality of rotary blades configured to cooperate with one another to compress air. Additionally, the turbine system 30 may include a plurality of turbine blades and/or nozzles. Hot gases emitted from the combustion system 20 may be directed to the turbine blades so as to impart rotational movement to the turbine blades. The thus imparted rotational movement may be utilized to drive one or more machines and or components (not shown) intended to be driven by the GTE 5. The layout of GTE 5 illustrated in FIG. 1 and described above is exemplary only. As such, the configuration and/or layout of GTE 5 may be different.

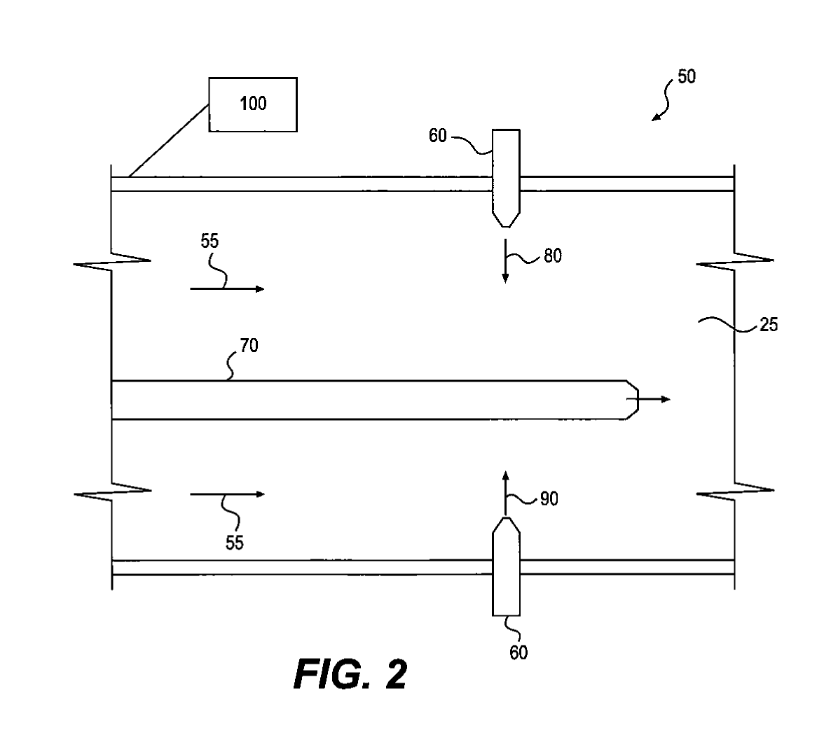

The combustion system 20 may further include one or more fuel injector systems 50. The compressed air may be mixed with a fuel and directed into the combustor 25 through the fuel injector system 50, schematically illustrated in FIG. 2. The fuel injector system 50 may be one of a plurality of fuel injector systems 50 configured to supply compressed air and fuel to the combustor 25. Compressed air may be received in an upstream portion of fuel injector system 50 and flow to a downstream portion as indicated by arrows 55. One or more types of fuel (such as, for example, a gaseous fuel and a liquid fuel) may be directed to the fuel injector system 50 through fuel lines (not identified). Fuel injector system 50 may include a plurality of injectors 60 spaced about fuel injector system 50. Each injector 60 of the plurality of injectors 60 may be configured to deliver a fuel into combustion system 20. As such, each injector 60 may include any appropriate shape, such as, for example, a jetted nozzle or frustum of a cone. The fuel injector system 50 may further include a pilot device 70. Pilot device 70 may be configured to deliver a rich fuel-air mixture into the combustor 25, as is known in the art. The fuel-air mixture may ignite and burn in the combustor 25 to produce combustion gases that may be directed to the turbine system 30. The layout of fuel injector system 50 illustrated in FIG. 2 and described above is exemplary only. Alternative arrangements and types of injectors 60 and/or pilot 70 may be employed without departing from the scope of the present disclosure.

Fuel injector system 50 may be configured to deliver multiple fuels into the combustion system 20 simultaneously. That is fuel injector system 50 may be configured to deliver a first fuel 80 and a second fuel 90 into the combustor 25 at the same time. One use for such simultaneous delivery of two fuels may be for transition between different fuel sources (i.e. a liquid to a gas fuel supply and vice versa). Thus, fuel injector system 50 may be configured to deliver a single fuel (i.e. first fuel 80) during a first mode of operation of the GTE 5, and introduce a second fuel (i.e. second fuel 90), simultaneously with the first fuel, during a second mode of operation of the GTE 5, as will be discussed in further detail below. Indeed, as discussed in further detail below, fuel injector system 50 may be configured to simultaneously deliver first fuel 80, comprising a liquid fuel, and second fuel 90, comprising a gas. It is understood that while fuel injector system 50 may introduce first fuel 80 and second fuel 90 simultaneously during a second mode of operation, fuel injector system 50 may be further configured to introduce only one of first fuel 80 and second fuel 90 during the second mode of operation. While FIG. 2 illustrates injectors 60 located at similar positions and having similar shapes, it is understood that the location and shapes of the injectors 60 may vary. Indeed, the location and shapes of such injectors may be different for liquid fuel delivery and gaseous fuel delivery.

In one exemplary embodiment, first fuel 80 may include a liquid fuel whereas second fuel 90 may include a gaseous fuel 90. Additionally, in one exemplary embodiment, second fuel 90 may include a low Wobbe fuel, whereas first fuel 80 may be a high energy fuel. Low Wobbe fuels are fuels having a low Wobbe index value. The Wobbe index is a value assigned to a particular fuel that demonstrates the combustion energy output of a particular fuel. That is, a low Wobbe fuel may be one in which a decreased amount of combustion energy output is achieved. Said differently, if two fuels have the same Wobbe index value, then for a given pressure setting, the combustion energy output will also be identical. For purposes of the present disclosure, a low Wobbe fuel is a fuel having a Wobbe index equal to or below 400 BTUs/ft³ and a high energy fuel is a fuel including a Wobbe index greater than 400 BTUs/ft³. In one exemplary embodiment, second fuel 90 may have a Wobbe index between 200 and 400 BTUs/ft³. Additionally, in one exemplary embodiment, the first fuel 80 may include natural gas liquid fuel and the second fuel 90 may include a hydrogen based or hydrocarbon based low Wobbe fuel. Alternatively, the first fuel may include at least one of a natural gas liquid fuel, a liquid petroleum gas fuel, a kerosene fuel, or a diesel fuel

The Wobbe index of a fuel is commonly measured in British Thermal Units per standard cubic foot (BTUs/ft³). Alternatively, the Wobbe index may be measured in Mega Joules per standard cubic meter (MJ/m³). The Wobbe index may be defined as:

$$WI = \frac{CV}{√ Gs} \qquad Equation 1$$

where WI is the Wobbe index; CV is the calorific value of a fuel; and Gs is the specific gravity.

GTE 5 may further include a controller 100, shown schematically in FIG. 2. Controller 100 may include all necessary components to manage injectors 60 and/or pilot 70. For example, controller 100 may include a memory, a secondary storage device, and a processor or other computer readable medium. Various circuits may be associated with controller 100 such as, for example, power supply circuitry, signal conditioning circuitry, and other appropriate circuitry. The controller 100 may be configured to send and receive signals to and from the various components within the GTE 5. These signals may include data from different sensors and commands instructing a component to perform a particular task. For example, controller 100 may be configured to receive manually inputted information and sensed data signals, and send instructions to control the type, pressure, and timing of fuel delivery through injectors 60.

Controller 100 may be configured to store different parameter values. These stored parameters may include user/manufacturer specified values and values calculated or otherwise determined by the controller 100. For instance, the stored parameters may include, among others, a skid-edge pressure limit (injection pressure limit) and a percentage load transition, as will be described in further detail below.

The stored skid edge pressure limit relates to an injection pressure limit for injectors 60 and/or pilot 70. That is, controller 100 may store a maximum rated injection pressure for a particular GTE 5. Said differently, controller 100 may store a maximum manufacturer suggested pressure for fuel injected via injectors 60, so as to maintain overall efficiency of GTE 5. In other words, the stored skid edge pressure limit refers to a target maximum injection pressure associated with introduction of a fuel, such as first fuel 80 and second fuel 90, into the combustion system 20 through injectors 60 and/or pilot 70. This skid edge pressure limit may be manufacturer set and based on physical specifications and the type of GTE 5. Operation of GTE 5 above the stored skid edge pressure limit (injection pressure limit) may result in inefficient GTE 5 functioning. Indeed, operation of GTE 5 above the stored skid edge pressure limit may result in parasitic losses of the GTE 5, as will be discussed in further detail below. In one exemplary embodiment, the skid edge pressure limit may be set to 400 pounds per square inch gauge (psig) (29.16 kilograms per square centimeter).

The stored percentage load transition may include a value predetermined by the controller 100. As is known, the load of GTE 5 is a value, measured in either kilowatts (KW) or horsepower (HP), relating to the demand placed on an engine (i.e. how hard the engine is working). During manufacture of GTE 5, a manufacturer may determine a suggested maximum rating of the load of GTE 5. That is, a manufacturer may determine a maximum suggested demand on GTE 5 so as to allow GTE 5 to operate efficiently. Indeed, a manufacturer may determine, through experimentation, simulation, or otherwise, a maximum rating of a GTE 5 to be between 1,590 HP and 30,000 HP depending on a variety of factors, as is known in the art. For exemplary purposes only, if GTE 5 is manufacturer rated for 30,000 HP, operation of GTE 5 at 30,000 HP would be considered operation of GTE 5 at 100% load (i.e. GTE 5 is working as hard as it is designed to). The suggested maximum rating of the load of GTE 5 may be stored in a memory of controller 100.

The stored percentage load transition may be associated with a percentage of load at which GTE 5 may be configured to transition from a first mode of operation to a second mode of operation, as will be discussed in further detail below. The stored percentage load transition may be calculated or otherwise determined based on a variety of inputs by an operator, inputs received from one or more sensors associated with GTE 5, and the manufacturer suggested rating of the load of GTE 5. For example, a user may manually input a variety of parameters into controller 100 such as, for example, a type of fuel and/or fuel composition to be injected into GTE 5, and/or an exhaust emissions limit. Additionally, controller 100 may receive a variety of inputs from sensors associated with GTE 5, such as, for example, a rotary shaft 40 speed signal and a temperature signal. Additionally or alternatively, controller 100 may be configured to receive different input parameters without departing from the scope of the present disclosure.

Based on the received inputs from the user, one or more sensors associated with GTE 5, and the stored suggested maximum load rating of GTE 5, controller 100 may determine an appropriate percentage load transition. That is, upon receiving relevant inputs, controller 100 may access a look-up table, map, or algorithm within the memory of controller 100 to determine a transition percentage load of GTE 5. For example, controller 100 may correlate the received inputs to calculate or otherwise determine an appropriate load percentage of GTE 5 at which GTE 5 is configured to transition from a first mode of operation to a second mode of operation, as will be discussed in further detail below. In one exemplary embodiment, the transition load percentage of GTE 5 may be 20%±5%. It is understood that the transition load percentage may be selected to be any desired value, as discussed in more detail below.

### INDUSTRIAL APPLICABILITY

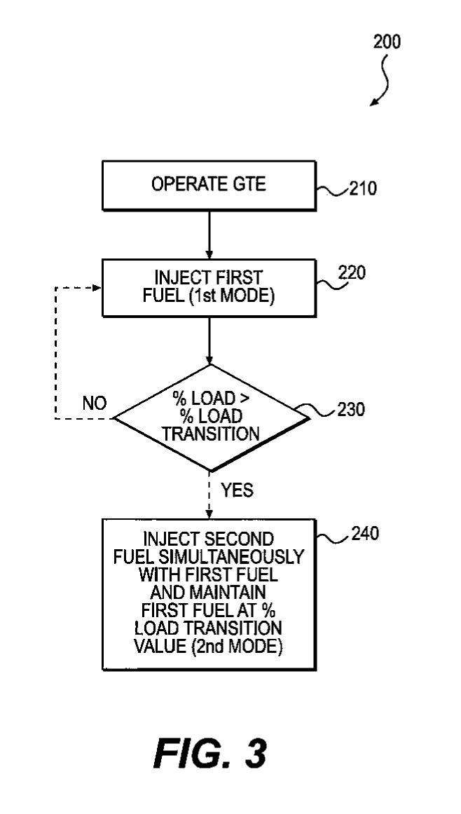

FIG. 3 depicts an exemplary method 200 of co-firing fuel within GTE 5. The disclosed method 200 of co-firing fuel within GTE 5 may be applicable to any GTE 5. In particular, the disclosed method 200 may be applicable in any GTE 5 in order to reduce parasitic losses of a GTE 5.

According to the presently disclosed method 200, GTE 5 may be operated at step 210. It is noted that this operation may include standard operation, start up, shut down, and fuel changes. That is, the presently disclosed method 200 may be employed throughout operation of GTE 5. For purposes of the present disclosure, standard operation may include any operation of GTE 5 not including start up, shut down, and fuel changes.

At step 220, first fuel 80 may be injected into combustion system 20 according to a first mode of operation. As load demand increases, an amount (i.e. mass flow) of first fuel 80 injected into GTE 5 may be increased, thereby satisfying the increased demand in GTE 5. It is understood that the first fuel 80 may be supplied by dedicated injectors 60 for the type of fuel injected, or may be injected by all of the injectors 60. For example, some of the injectors 60 may be configured so as to be dedicated for injection of a certain type of fuel, such as a liquid fuel, while other injectors 60 may be configured so as to be dedicated for injection of gaseous fuels.

At step 230, a percentage load transition may be determined and compared with an actual percentage load of GTE 5. The percentage load transition may be determined, as described above. For example, upon receiving inputs from the user, one or more sensors associated with GTE 5, and the stored suggested maximum load rating of GTE 5, controller 100 may determine an appropriate percentage load transition. That is, upon receiving relevant inputs, controller 100 may access a look-up table, map, or algorithm within the memory of controller 100 to determine a percentage load transition of GTE 5. For example, controller 100 may correlate the received inputs to calculate or otherwise determine an appropriate load percentage of GTE 5 at which GTE 5 is configured to transition from a first single fuel mode of operation to a second dual co-fire mode of operation.

As stated above, the percentage load transition may be compared with an actual percentage load of GTE 5 at step 230. The actual percentage load of GTE 5 may be sensed through an appropriate sensor associated with the GTE 5. A signal representing the actual percentage load of GTE 5 may then be transmitted to the controller 100 through any appropriate means. After receiving the actual percentage load of GTE 5, controller 100 may compare the actual percentage load of GTE 5 with the percentage load transition previously determined. If the controller 100 determines that the actual percentage load of GTE 5 is greater than the percentage load transition, method 200 may continue to step 240.

At step 240, GTE 5 may transition to a second dual fuel co-fire mode. That is, after surpassing the transition load percentage, second fuel 90 may be injected into combustion system 20 of GTE 5. Indeed, the second fuel 90 may include a low Wobbe fuel and be injected simultaneously with first fuel 80 at step 240. At this point, the amount (i.e. mass flow) of first fuel 80 injected into combustion section 20 may be held constant after GTE 5 reaches the percentage load transition, while the amount (i.e. mass flow) of second fuel 90 injected is increased. For example, in an embodiment in which the transition load percentage is selected as 20%, a mass flow of first fuel 80 may be steadily increased so as to enable GTE 5 to achieve a load demand of between 0 and 20% load. After exceeding 20% load, however, a mass flow of first fuel 80 may be maintained at its current rate, and the second low Wobbe fuel 90 may be injected to supplement first fuel 80. It is to be noted that first fuel 80 and second fuel 90 are injected into combustion system 20 discrete from one another. That is, while first fuel 80 and second fuel 90 are injected simultaneously, they are not premixed prior to being injected.

If, however, the controller 100 determines that the actual percentage load of GTE 5 is not greater than the percentage load transition in step 230, method 200 may revert back to step 220. That is, first fuel 80 may be continued to be injected into combustion system 20 according to the first mode of operation.

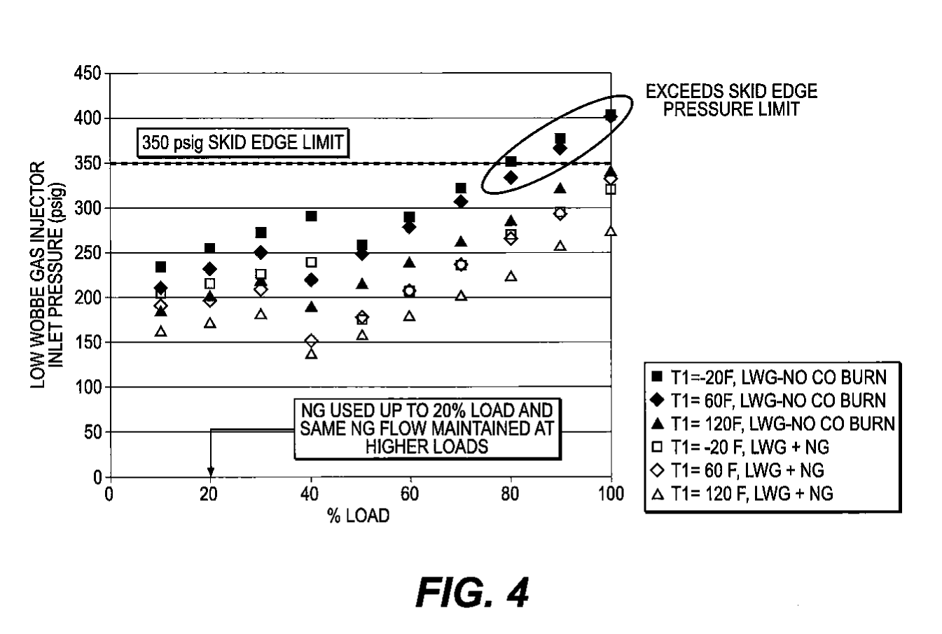

FIG. 4 depicts an exemplary graphical representation comparing the skid-edge pressure (injection pressure) to the percentage load of an exemplary GTE 5. As shown in FIG. 4, and for exemplary purposes only, the skid edge pressure limit has been set to 350 pounds per square inch gauge (psig) (25.64 kilograms per square centimeter) and the percentage load transition has been set to 20%. As noted on FIG. 4, a first fuel 80 (labeled NG and referring to natural gas liquid fuel) is introduced up to the 20% load transition, and subsequently, a second fuel 90 (labeled LWG and referring to low wobbe gas) is introduced thereafter, up to 100% load of GTE 5. As shown in the legend of FIG. 4, the first three trials, indicated by a solid square marker, a solid diamond marker, and a solid triangle marker, were conducted by introduction of only the second fuel 90 (i.e. without simultaneous co-firing of the second fuel 90 with the first fuel 80), at various operating temperatures in degrees Fahrenheit. The latter three trials, indicated by a square outline, a diamond outline, and a triangular outline, were conducted with the simultaneous introduction (i.e. co-firing) of the first fuel 80 and the second fuel 90, at various operating temperatures in degrees Fahrenheit. As can be seen, each of the first and second trials, conducted without co-firing of the first fuel 80 and the second fuel 90, exceed the predetermined 350 psig skid edge pressure limit, whereas the third trial fell just shy of the predetermined 350 psig skid edge pressure limit. The latter three trials, conducted according to embodiments of the disclosed method by co-firing first 80 and second 90 fuels remained well below the predetermined skid edge pressure limit.

As noted above, the second fuel 90 used in the second mode of operation includes a low Wobbe fuel. Low Wobbe fuels (i.e. low calorific fuels) may be utilized in a variety of circumstances. For example, low Wobbe fuels may be readily manufactured or obtained as needed and do not depend on other sources, such as, for example, foreign fuel supplies etc. While low Wobbe fuels may be readily available, such fuels may lead to varying GTE 5 conditions. For example, since a low Wobbe fuel is one which provides a lower combustion energy output, a greater amount of a low Wobbe fuel may be required for a given demand on GTE 5. That is, in comparison to a higher combustion energy output fuel, more low Wobbe fuel may be required to achieve a certain energy output. Stated differently, assuming all other conditions remain steady (i.e. there are no other variables), it will take a greater mass flow amount of low Wobbe fuel to achieve a target energy output than it will take of a higher Wobbe fuel to achieve the same target energy output. As such, an increased mass flow of a low Wobbe fuel may be required into GTE 5.

In order to inject an increased amount of low Wobbe fuel, such as second fuel 90, into combustion system 20, a greater pressurization of second fuel 90 may be required. That is, in order to introduce a greater amount of low Wobbe fuel into combustion system 20 in the same amount of time, the low Wobbe fuel must be pressurized to a greater degree so as to allow the increased amount of low Wobbe fuel to be received within GTE 5 for combustion. In order to properly compress low Wobbe fuels, a pump or other supplemental compressing apparatus must be utilized. That is, for example, a secondary compressor/pump may be employed to compress a low Wobbe fuel prior to injection within combustion system 20. Often, however, such a secondary compressor/pump is driven by an electric motor powered via an electrical system driven by the GTE 5 or a grid, as is known in the art. That is, a portion of the power output of GTE 5 may be redirected or apportioned to drive the secondary compressor or pump. As such, a reduction in the useful power output of GTE 5, i.e. a parasitic loss, may be observed when using a low Wobbe fuel.

Introduction of a greater mass flow amount of a low Wobbe fuel may also cause a distribution effect across various injectors 60 of fuel injector system 50. That is, the greater the amount of a low Wobbe fuel that is introduced into GTE 5, the greater the chance of injectors 60 injecting varying amounts of a low Wobbe fuel, thereby causing an injected fuel distribution across injectors 60. Indeed, due to the required increased pressurization of low Wobbe fuels prior to injection, as discussed above, the injection of low Wobbe fuel may result in varying amounts (i.e. error) of low Wobbe fuel being injected via one or more injectors 60. Such a distribution can lead to an increased amount of unburned chemical constituents, such as carbon monoxide, and may result in a reduction of emissions quality of the GTE 5. Additionally, such a distribution may lead to varying temperatures within GTE 5. Indeed, in areas where a higher amount of low Wobbe fuel is introduced, increased heat may be produced during combustion. Such temperature fluctuations may result in increased wear within GTE 5. That is, parts exposed to greater degrees of heat may expand to a larger extent, and thereby increase wear on components within GTE 5. Such wear may result in downtime of GTE 5 for replacement or repair of components affected by such heat fluctuations.

The presently disclosed method for operating the GTE 5 may have numerous features. Indeed, since first fuel 80 is co-fired with second fuel 90, a smaller mass flow amount of second fuel 90 is required to operate GTE 5 at a desired load. That is, in an embodiment in which second fuel 90 includes a low Wobbe fuel, co-firing second fuel 90 with first fuel 80 may reduce the amount of low Wobbe fuel necessitated by GTE 5. As such, GTE 5 is made increasingly efficient as there is a reduced need to utilize a supplemental compressor/pump in order to pressurize second fuel 90. As such, parasitic losses of GTE 5 may be avoided.

Further, the presently disclosed method 200 may reduce the mass flow amount of low Wobbe fuel required to operate GTE 5. That is, since low Wobbe second fuel 90 is co-fired into GTE 5 simultaneously with a higher combustion energy output first fuel 80, a reduced amount of low Wobbe second fuel 90 is necessary. Such a reduction further enhances overall efficiency of GTE 5. Also, reduction of the mass amount of low Wobbe second fuel 90 reduces distribution effects (i.e. varying amounts of low Wobbe injected by injectors 60) caused by injection of a low Wobbe fuel as discussed above. By reducing the distribution effects of operation with low Wobbe fuels, a reduction in unburned fuel, leading to harmful emissions exhaust, may be avoided. As such, the presently disclosed method 200 may reduce negative emissions caused by operation of GTE 5.

Also, the presently disclosed method 200 may reduce temperature variations within GTE 5. That is, by reducing an uneven distribution of low Wobbe second fuel 90 within GTE, an increasingly constant combustion temperature may be realized. Said differently, in areas where a higher amount of low Wobbe fuel is introduced, increased heat may be produced during combustion. By reducing areas having a higher concentration of low Wobbe second fuel 90, hot spots within GTE 5 may be avoided. As such, a reduction in failure or damage of components of the GTE 5 may be achieved, thereby reducing GTE 5 downtime. Finally, the simultaneous injection of two different types of fuel, can utilize fuel injection systems that are configured to supply different fuels, such as a dual-fuel injectors that include separate dedicated fuel injection structures for supplying different fuels (i.e. liquid fuels and gaseous fuels).

It will be apparent to those skilled in the art that various modifications and variations can be made to the disclosed method of co-firing fuels within GTE 5. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A method of co-firing fuel within a gas turbine engine, comprising:
injecting a first fuel into a combustion system of a gas turbine engine, the first fuel including a high energy liquid fuel; and
injecting a second fuel into the combustion system, the second fuel including a gaseous low Wobbe fuel;
wherein only the first fuel is injected during a first mode of operation; and
wherein the first fuel and the second fuel are injected simultaneously and discretely during a second mode of operation.

2. The method of claim 1, wherein a Wobbe index of the second fuel is between 200 and 400 BTUs/ft³.

3. The method of claim 1, wherein the second fuel is a hydrogen-based fuel or a hydrocarbon-based fuel and the first fuel is at least one of a natural gas liquid fuel, a liquid petroleum gas fuel, a kerosene fuel, or a diesel fuel.

4. The method of claim 1, wherein the first mode of operation is continues until a transition percentage load has been exceeded, wherein the transition percentage load is a function of one or more of a variety of inputs by an operator, inputs received from one or more sensors associated with the gas turbine engine, and a manufacturer suggested rating of the load of the gas turbine engine.

5. The method of claim 1, further including:
operating the gas turbine engine, wherein operating the gas turbine engine includes standard operation.

6. The method of claim 1, wherein the second fuel is injected below a predetermined injection pressure limit.

7. A method of co-firing fuel within a gas turbine engine, comprising:
determining a transition percentage of load of the gas turbine engine;
injecting a first fuel into a combustion system of the gas turbine engine, the first fuel including a high energy liquid fuel; and
co-firing the first fuel with a second fuel in the combustion system after exceeding the transition percentage load of the gas turbine engine, the second fuel including a gaseous low Wobbe fuel;
wherein the first fuel and the second fuel are co-fired discretely of each other; and
wherein the transition percentage load is a function of one or more of a variety of inputs by an operator, inputs received from one or more sensors associated with the gas turbine engine, and a manufacturer suggested rating of the load of the gas turbine engine.

8. The method of claim 7, wherein the transition percentage of load is 20%.

9. The method of claim 7, further including:
maintaining an amount of the first fuel injected into the combustion system constant after the gas turbine engine exceeds the transition percentage of load while increasing a percentage load on the gas turbine engine.

10. The method of claim 7, further including:
accessing a stored look up table, map, or algorithm to determine the transition percentage of load.

11. The method of claim 7, further including:
operating the gas turbine engine, wherein operating the gas turbine engine includes standard operation.

12. The method of claim 7, wherein the first fuel is at least one of a natural gas liquid fuel, a liquid petroleum gas fuel, a kerosene fuel, or a diesel fuel.

13. The method of claim 7, wherein the second fuel is a hydrogen-based fuel or a hydrocarbon-based fuel.

14. The method of claim 7, wherein a Wobbe index of the second fuel is between 200 and 400 BTUs/ft³.

15. A method of co-firing fuel within a gas turbine engine, comprising:
injecting a first fuel into a combustion system of a gas turbine engine during a first mode, the first fuel including a high energy liquid fuel;
determining a transition percentage of load of the gas turbine engine; and
co-firing the first fuel with a second fuel in the combustion system after exceeding the transition percentage load of the gas turbine engine during a second mode, the second fuel including a gaseous low Wobbe fuel; and
maintaining an amount of first fuel injected into the combustion system constant during the second mode while increasing a percentage load on the gas turbine engine;
wherein the first fuel and the second fuel are co-fired discretely of each other; and
wherein the second fuel is injected below a predetermined injection pressure limit.

16. The method of claim 15, further including:
operating the gas turbine engine, wherein operating the gas turbine engine includes standard operation.

17. The method of claim 15, wherein the first fuel is at least one of a natural gas liquid fuel, a liquid petroleum gas fuel, a kerosene fuel, or a diesel fuel.

18. The method of claim 15, wherein the second fuel is a hydrogen-based fuel or a hydrocarbon-based fuel.

19. The method of claim 15, wherein a Wobbe index of the second fuel is between 200 and 400 BTUs/ft³.

20. The method of claim 15, wherein the transition percentage of load is 20%.
